(19) United States
(12) Patent Application Publication
(10) Pub. No.: US 2010/0140932 A1
(43) Pub. Date: Jun. 10, 2010

(54) TAPERED NUT FOR TUBE OR PIPE FITTING

(75) Inventors: Peter C. Williams, Cleveland Heights, OH (US); Dale C. Arstein, Cleveland Heights, OH (US)

Correspondence Address: CALFEE HALTER & GRISWOLD, LLP, 800 SUPERIOR AVENUE, SUITE 1400, CLEVELAND, OH, 44114, US

(73) Assignee: SWAGELOK COMPANY, Solon, OH (US)

(21) Appl. No.: 12/670,269

(22) PCT Filed: Jul. 24, 2008
(86) PCT No.: PCT/US08/70991

§ 371 Date: Jan. 22, 2010

Related U.S. Application Data
(60) Provisional application No. 60/962,239, filed on Jul. 27, 2007.

(51) Int. Cl. F16L 25/00; F16L 19/00

(52) U.S. Cl. 285/389; 285/386

(57) ABSTRACT

A drive nut (918) for a fitting includes an interior socket centered on a central axis and configured to receive at least a rearward portion of a conduit gripping member. The socket is defined by a radial drive surface (932) positioned to engage the conduit gripping member during pull-up, a first tapered longitudinal surface (940) radially outward of said drive surface and a second tapered longitudinal surface (934) between the drive surface and the first tapered longitudinal surface.

### CROSS-REFERENCE TO RELATED APPLICATION

This application claims the benefit of U.S. provisional patent application Ser. No. 60/962,239, entitled TAPERED NUT FOR TUBE OR PIPE FITTING and filed Jul. 27, 2007, the entire disclosure of which is fully incorporated herein by reference.

### BACKGROUND OF THE INVENTION

Fittings may be used to join or connect the end of a tube or other conduit to another member, whether that other member be another tube or conduit end such as through T-fittings and elbow fittings, for example, or a device that needs to be in fluid communication with the tube end, such as for example, a valve. One type of fitting uses a gripping arrangement including two ferrules that provide a gripping and sealing action between a tube and a body under the influence of a female threaded drive nut. Other types of fittings are also known, such as, for example, single ferrule fittings, fittings that use other types of tube gripping devices, and fittings that use male threaded drive nuts.

Tube fitting components that are radially displaced or expanded upon pull-up take up a portion of the deformation energy of pull-up and may contact radially adjacent and/or radially nearby fitting component surfaces as a result of the expansion or displacement. For example, the tubing inboard of the tube gripping member, such as, for example, the front ferrule of a two ferrule fitting or the ferrule of a single ferrule fitting, may expand radially outward during fitting pull-up and takes up a portion of the deformation energy of pull-up.

### SUMMARY OF THE INVENTION

The application pertains generally to a fitting assembly that is configured to assist in separating two or more fitting components during disassembly of the fitting if and when the mating components contact each other during pull-up, for example, due to radially outward movement of a fitting component as a result of axial compression of the fitting component during fitting installation. As used herein, fitting components of a fitting assembly may include, but are not limited to, bodies, such as, for example, coupling bodies and valve bodies, drive nuts, tube gripping members, such as, for example, ferrules, tubing or other conduits, and fitting installation tools, such as, for example, tube gripping member installation tools or pre-swaging tools.

According to one inventive aspect, one or more fitting component engaging surfaces may be configured to reduce radial reaction forces between two contacting fitting components of a pulled-up fitting. For example, a surface of a first fitting component that is axially aligned with a second fitting component during fitting assembly may be radially recessed to provide reduced radial reaction forces between the recessed surface and the second component during disassembly. As used herein, two components are “axially aligned” if a portion of the first component is located at the same axial position (e.g., a position along a fitting) as a portion of the second fitting component. As another example of fitting components configured to reduce radial reaction forces resulting from contact between fitting components of a pulled-up fitting, a surface of a first fitting component that contacts a second fitting component during fitting assembly may be axially shortened to reduce a length of contact between the first and second components and, as a result, to provide reduced radial reaction forces between the first and the second components during disassembly.

According to another inventive aspect, one or more fitting component mating surfaces may additionally or alternatively be configured to produce an axial component of reaction force between two contacting fitting components of a pulled-up fitting. This axial component of elastic reaction force may assist in separating the two fitting components during disassembly of the pulled-up fitting. For example, a first fitting component may include a stepped wall surface, which may, for example, include a tapered surface, that contacts a second fitting component during fitting pull-up (e.g., during initial fitting pull-up and/or during a subsequent re-make) to produce an axial component of reaction force, which may assist in separation of the first and second fitting components when the fitting is disassembled.

Accordingly, in one exemplary embodiment, a fitting assembly has a first fitting component having a stepped wall surface and a second fitting component radially spaced from the tapered longitudinal surface when the fitting assembly is in a finger tight condition prior to pull-up. When the second fitting component is radially displaced into contact with the stepped wall surface during fitting pull-up, the stepped wall surface assists in separating the first fitting component from the second fitting component upon fitting disassembly. For example, engagement of the second fitting component with the stepped wall surface may produce an axial component of reaction force that assists in axially moving the second fitting component away from the first fitting component. As another example, the stepped wall surface may provide for a reduced radial reaction force between the first and second fitting components upon initial axial movement of the second fitting component during fitting disassembly.

In another embodiment, a drive nut is provided with an inner wall having a tapered longitudinal surface, such that when a tube gripping member that is assembled with the drive nut and a fitting body is displaced into contact with the tapered longitudinal surface, an axial component of elastic reaction force resulting from this contact may assist in separating the tube gripping member from the drive nut upon disassembly of the fitting. Additionally, the tapered condition of the longitudinal wall may reduce the radial force between the drive nut and the tube gripping member during separation of the tube gripping member from the drive nut, for example, by providing radial separation between the tube gripping member and at least a portion of the tapered surface during fitting disassembly.

In another embodiment, a drive nut has a drive surface that engages a back end of a conduit gripping member, and this drive surface is typically formed at an angle relative to a central longitudinal axis of the tube fitting. A first tapered surface is provided that extends axially away from the nut drive surface. A second tapered surface is disposed between the drive surface and the first tapered surface to further enhance the benefits of the drive surface. For example, the second tapered surface may reduce pull-up torque, may provide axial reaction forces to assist in disassembly of the fitting and may reduce radial forces between the conduit gripping member and the nut after pull-up. The second tapered surface may also assist in centering the conduit gripping member within the nut socket.

In still another embodiment, a tube fitting includes a tube gripping device having a first ferrule, a fitting body having a tube end socket for receiving a tube end, and a drive nut for assembly with the fitting body. The drive nut includes a recessed portion sized to receive the first ferrule. The recessed portion includes a radial drive surface for driving the first ferrule into engagement with a tube end during pull-up on the fitting body; a first tapered longitudinal surface that is radially spaced from a radially outer surface of the first ferrule when the tube fitting is in a finger-tight condition; and a second tapered longitudinal surface between the drive surface and the first tapered longitudinal surface. The second tapered longitudinal surface is angled with respect to both the drive surface and the first tapered longitudinal surface. When the drive nut is pulled up with the fitting body (e.g., during initial fitting pull-up or during a subsequent re-make), the first ferrule is radially displaced into contact with the first tapered longitudinal surface.

In yet another embodiment, a method of assembling a tube fitting with a tube end is contemplated for a tube fitting having a fitting body, a drive nut, and a ferrule. The tube end is inserted into a tube end socket of the fitting body. The ferrule is positioned in a recessed portion of the drive nut. The drive nut is assembled with the fitting body to a finger-tight position, such that the ferrule engages a radial drive surface of the drive nut and is radially spaced from a first tapered longitudinal surface of the drive nut by at least a portion of a second tapered longitudinal surface disposed between the drive surface and the first tapered longitudinal surface. The drive nut is pulled up on the fitting body, such that the ferrule is radially displaced into contact with the first tapered longitudinal surface.

Further advantages and benefits will become apparent to those skilled in the art after considering the following description in conjunction with the accompanying drawings.

### BRIEF DESCRIPTION OF THE DRAWINGS

These and other inventive aspects and features of the present disclosure will become apparent to one skilled in the art to which the present invention relates upon consideration of the following description of the exemplary embodiments with reference to the accompanying drawings, in which:

FIG. 1 is a partial sectional view of a tube fitting having a drive nut with a tapered inner wall surface, shown in a finger tight condition before pull-up of the fitting;

FIG. 1A is an enlarged sectional view of a portion of the drive nut and ferrules of the fitting of FIG. 1;

FIG. 2 is a partial sectional view of the tube fitting of FIG. 1 in a pulled-up condition;

FIG. 3 is a partial sectional view of a single ferrule type tube fitting having a drive nut with a tapered inner wall surface, shown in a finger tight condition before pull-up of the fitting;

FIG. 4 is an enlarged partial sectional view of the tube fitting of FIG. 3 in a pulled-up condition;

FIG. 5 is a partial sectional view of a tube fitting with a female threaded body and a male threaded drive nut with a tapered inner wall surface, shown in a finger tight condition before pull-up of the fitting;

FIG. 6 is an enlarged partial sectional view of the tube fitting of FIG. 5 in a pulled-up condition;

FIG. 7 illustrates a sectional view of another embodiment of a tube fitting, having a drive nut with tapered interior surfaces on the right half of the drawing and a known drive nut on the left half of the drawing, in longitudinal cross-section;

FIG. 7A illustrates a partial sectional view of the tube fitting of FIG. 7, shown in a pulled-up condition; and

FIG. 8 is an enlarged illustration of the tapered interior surfaces of the drive nut of FIG. 7 with the back ferrule and conduit end omitted for clarity.

### DETAILED DESCRIPTION OF EXEMPLARY EMBODIMENTS

This disclosure relates to fitting components, for use with any type of fluid conduit, including tube or pipe. The exemplary embodiments are described herein with the terms “tube” and “tubing,” but may be used with pipe and other conduits. The disclosure is applicable to fitting components of varying constructions, materials, sizes, and dimensions such as diameters, for example, all of which are described herein with the term “tube fitting.” The tightening or preparation of a fitting connection is referred to herein as fitting “pull-up” or “make up,” with both terms being used interchangeably. Fitting pull-up or make up is not limited to a specific pull-up position.

Tube fitting components that are radially displaced or expanded upon fitting pull-up may contact radially adjacent and/or radially spaced fitting component surfaces as a result of the expansion or displacement. Examples of this radially outward movement include bowing or barreling of a tube end resulting from axial compression of the tube end, or outward deflection of portions of a tube gripping member, such as a ferrule or ferrules, during fitting pull-up. This contact may occur during initial pull-up of a fitting. Alternatively, this contact may not occur until a subsequent remake of the fitting, upon additional incremental displacement of the fitting component after two or more pull-ups of the fitting.

The present application contemplates providing a fitting that may be configured to assist in the separation of these contacting fitting components during disassembly of the fitting, for example, by reducing radial reaction forces (which tend to resist separation) between the components, or by increasing axial reaction forces (which tend to promote separation) between the components. According to one inventive aspect, this assistance in separating the components may be accomplished by providing a first fitting component with a recessed surface radially spaced from a surface that engages a displaced portion of a second component upon fitting pull-up. As the second component is separated from the first component during fitting disassembly, the displaced portion is axially aligned with the recessed surface, causing radial reaction forces between the first and second fitting components to be reduced, thus facilitating further separation of the first and second fitting components.

According to another inventive aspect, assistance in separating contacting first and second fitting components may be accomplished by providing the first fitting component with a tapered longitudinal surface for engagement with a displaced portion of the second fitting component. For example, a tube end socket may include a tapered longitudinal wall to assist in removal of a tube end. As another example, a drive nut may include one or more tapered longitudinal surfaces on an inner wall to assist in separation of the drive nut from a tube gripping device, such as, for example, a ferrule or ferrules. In yet another exemplary embodiment, both the tube end socket and the drive nut may include tapered longitudinal surfaces to assist in separation from the tube end and tube gripping device, respectively.

An exemplary type of fitting with which the invention can be used includes two ferrules that provide a gripping and sealing action between a tube and a body under the influence of a female threaded drive nut. While exemplary embodiments illustrated and described herein show various inventive aspects as used with this two ferrule type fitting, these inventive aspects are also applicable to other types of fittings, such as, for example, single ferrule fittings, fittings that use other types of tube gripping devices, and fittings that use male threaded drive nuts. Also, while exemplary embodiments include fittings for use with stainless steel tubing having diameters of ¼ inch (6.4 mm), ⅜ inch (12.7 mm), and ½ inch (19.0 mm), the inventive aspects of the present application may be provided with fittings for use with many sizes and types of tubing.

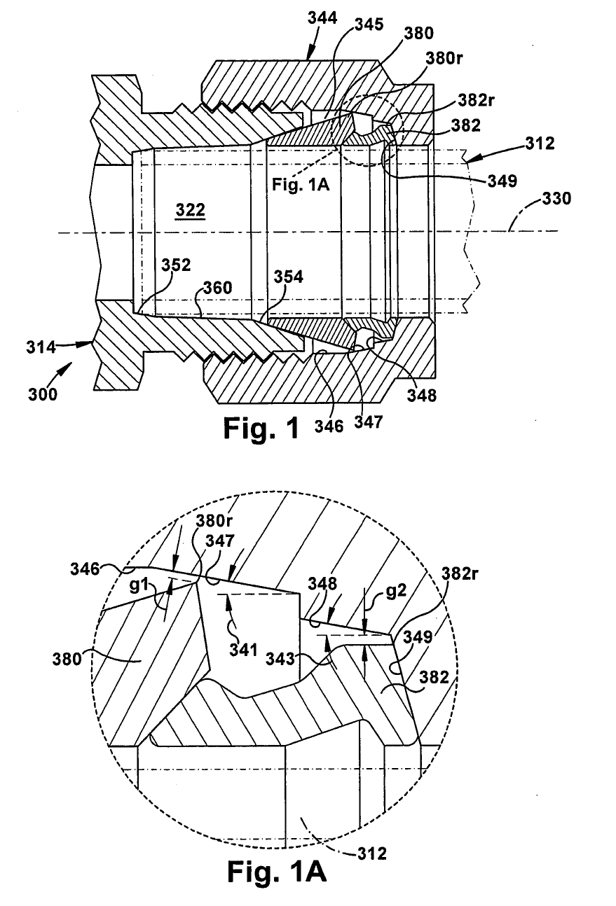

In accordance with other inventive aspects, one or more tapered longitudinal surfaces may be provided on one or more other fitting assembly components. In one embodiment, a tapered longitudinal surface may be provided on an inner wall of a drive nut of a fitting assembly to engage a portion of a tube gripping device assembled with the fitting when a portion of the tube gripping device is displaced outward and into contact with the inner wall of the nut during pull-up (e.g., during initial fitting pull-up, or after one or more subsequent pull-ups). This contact between the tapered longitudinal surface and the tube gripping device produces an axial component of an elastic reaction force against the tube gripping device, which can assist in separation of the nut from the tube gripping device upon fitting disassembly. FIGS. 1-8 illustrate exemplary embodiments of fittings including drive nuts having one or more of such tapered longitudinal surfaces.

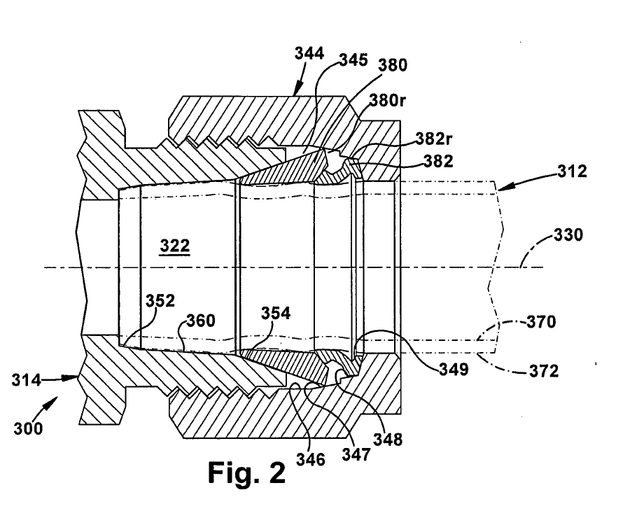

According to one embodiment, FIGS. 1 and 2 illustrate a two-ferrule tube fitting 300. The tube fitting 300 may be used for connection with a tube 312 and includes a fitting body 314. The fitting body 314 is merely representative of the various different types of assemblies and fittings with which the invention is usable. For example, the fitting body can be a standalone device, or a portion of a valve, or a union, or any other type of fluid control device or fluid flow device. Further, the fitting body 314 may, but need not, be provided with recessed or tapered longitudinal surfaces, such as, for example, the tapered tube capture and tube end socket wall surfaces described in co-pending PCT application Publication No. WO 2007/087043, filed Dec. 15, 2006, the entire disclosure of which is incorporated herein by reference. The particular tube fitting 300 that is shown in FIGS. 1 and 2 includes, in addition to the fitting body 314, a front ferrule 380, a rear ferrule 382, and a drive nut 344.

FIGS. 1 and 1A illustrate the fitting 300 in a finger tight condition prior to pull-up. The tube 312 is inserted through the nut 344 and into the socket 322. The front ferrule 180 is disposed in a first portion of a recess 345 in the nut 344, and the rear ferrule 382 is disposed in a second portion of the recess 345. Included in the recess is a frustoconical drive surface 349 for driving the ferrules 380, 382 into engagement with the tubing 312 during pull-up.

FIG. 2 illustrates the fitting 300 after pull-up. The drive nut 344 is screwed further onto the fitting body 314. The movement of the drive nut 344 causes the ferrules 380 and 382 to provide a gripping and sealing engagement between the tube 312 and the fitting body 314.

Axially and radially inward movement of a nose of the front ferrule 380 may cause an outer portion 380r of the front ferrule 380 to expand or deflect outward. Likewise, axially and radially inward movement of an inner, gripping portion of the rear ferrule 382 may cause an outer portion 382r of the rear ferrule 382 to expand or deflect outward. Under some circumstances, one or both of these outer portions 380r, 382r of the ferrules 380, 382 may contact an inner wall 346 of the drive nut 344 during pull-up. In the exemplary embodiment of FIGS. 1 and 2, tapered longitudinal surfaces 347, 348 are provided on the inner wall 346 at locations axially aligned with the front and rear ferrules 380, 382. It should be noted that in other exemplary embodiments, tapered longitudinal surfaces may be provided axially aligned with only one of the two ferrules, or one continuous tapered longitudinal surface on the inner wall may extend to be axially aligned with both ferrules (not shown). In the illustrated embodiment of FIGS. 1 and 2, when the outer portions 380r, 382r of the front and rear ferrules 380, 382 deflect during pull-up, as shown in FIG. 2, one or both of the outer portions 380r, 382r may contact a corresponding one or both of the tapered longitudinal surfaces 347, 348, resulting in both a radial and an axial component of reaction force.

The tapered condition of these inner wall surfaces 347, 348 can assist in separation of the nut 344 from one or both ferrules 380, 382 upon disassembly. The axial component of reaction force produced by contact between the tapered surfaces 347, 348 and the ferrule or ferrules 380, 382 can assist in separation of the nut 344 from either or both of the ferrules 380, 382. Once the ferrule or ferrules 380, 382 are initially broken free from the tapered wall surfaces 347, 348, the nut 344 may be separated without any substantial force, due to the resulting radial separation or reduction in radial reaction force between the ferrule or ferrules 380, 382 and the tapered wall surfaces 347, 348.

To provide both sufficient radial containment of the ferrules and a sufficient axial reaction force between contacting nut and ferrule surfaces during disassembly, the taper angles 341, 343 of the inner wall surfaces 347, 348 of the drive nut 344, as measured from the axis 330 of the drive nut, may, for example, each range from greater than 0° up to approximately 45°. These two angles 341, 343 may, but need not, be the same. In an exemplary embodiment, the taper angles 341, 343 may each range from about 5° up to about 30°, and in a more preferred, but not required embodiment, the tapered angles 341, 343 may each range from about 10° to about 20°. In the illustrated embodiment of FIGS. 1 and 2, the tapered wall surfaces 347, 348 each have a taper angle 341, 343 of about 10° relative to the axis 330.

As described above, the taper angle of the tapered wall surface in a drive nut may be selected to assist in separation of the drive nut from the tube gripping device, such as, for example, a ferrule or ferrules, if any portion of the tube gripping device is expanded or deflected radially outward into engagement with the inner wall of the drive nut during pull-up. Additionally, a gap between the outer portion or portions of the tube gripping device and the tapered longitudinal surface or surfaces of the drive nut in the fitting's pre-tightened, finger tight condition may be selected independently or in combination with the taper angle to provide a desired radial reaction load between the outer portions of the ferrule or ferrules and the inner wall of the drive nut, to assist in tightening the tube gripping device to the tube end. In an exemplary embodiment, as shown in FIG. 1A, a gap g1 is provided between the front ferrule outer portion 380r and the tapered longitudinal surface 347, and a gap g2 is provided between the rear ferrule outer portion 382r and the tapered longitudinal surface 348. The dimensions of these gaps and the taper angles of the tapered longitudinal surfaces may be varied to produce desired radial reaction forces during fitting pull-up, such as, for example, to produce radial reaction forces consistent with those experienced during pull-up of the fitting 300 with a nut having cylindrical (non-tapered) inner wall surfaces. As such, a drive nut 344 with tapered longitudinal surfaces may be interchangeable with a nut having cylindrical inner wall surfaces, thereby allowing use of the same fitting body and tube gripping device. In one such exemplary embodiment, a tube fitting 300 for ½ inch tubing includes a gap g1 of approximately 0.010 inches (0.25 mm) between the front ferrule 380 and the tapered longitudinal surface 347, and a gap g2 of approximately 0.009 inches (0.23 mm) between the rear ferrule 382 and the tapered longitudinal surface 348.

According to another inventive aspect, tapered longitudinal surfaces may be provided on multiple components of a fitting to assist in the separation of multiple sets of contacting fitting components during fitting assembly. In one embodiment, tapered longitudinal surfaces are provided both on an inner wall of a body tube socket and on an inner wall of a drive nut, for separation from the tube end and tube gripping device, respectively, during fitting disassembly. In the illustrated exemplary embodiment of FIGS. 1 and 2, in addition to the tapered longitudinal surfaces 347, 348 on the nut 344, as described above, a tapered intermediate socket wall surface 360 is provided between a tube capture portion 352 and a cammming mouth 354, which may assist in separation of the fitting body 314 from the tube 312 during disassembly of the pulled-up fitting 300.

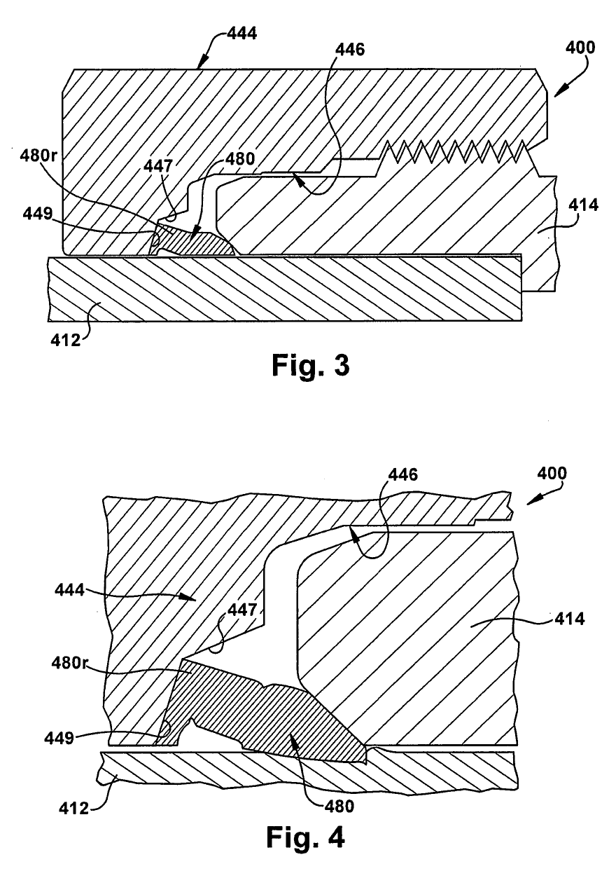

FIGS. 3 and 4 illustrate a fitting 400 that is another exemplary embodiment in which a tapered longitudinal surface 447 is provided on an inner wall of a drive nut 444. The exemplary fitting of FIGS. 3 and 4 is a single ferrule design, similar to a single ferrule tube fitting described in U.S. Pat. No. 7,393,018, entitled Tube Fitting for Stainless Steel Tubing, the entire disclosure of which is fully incorporated herein by reference.

During pull-up of the illustrated tube fitting, axially and radially inward movement of a nose of the single ferrule 480 may cause an outer portion 480r of the front ferrule 480 to expand or deflect outward. Under some circumstances, this outer portion 480r of the ferrule 480 may contact an inner wall 446 of the drive nut 444 during pull-up, causing a radial reaction load between the outer portion 480r of the ferrule 480 and the inner wall 446 of the drive nut 444. In the exemplary embodiment of FIGS. 3 and 4, a tapered longitudinal surfaces 447 is provided on the inner wall 446 at a location axially aligned with and radially spaced from the ferrule 480. When the outer portion 480r of the ferrule 480 deflects during pull-up, as shown in FIG. 4, the outer portion 480r may contact the tapered longitudinal surface 447, resulting in both a radial and an axial component of reaction force. The tapered condition of the inner wall surface (as opposed to, for example, a cylindrical surface) can assist in separation of the nut 444 from the ferrule 480 upon disassembly, as the axial component of reaction force can assist in separation of the nut 444 from the ferrule 480. Once the ferrule 480 is initially broken free from the tapered wall surfaces 447, the nut 444 can be separated without any substantial force, because of the taper angle of the tapered longitudinal surface 447.

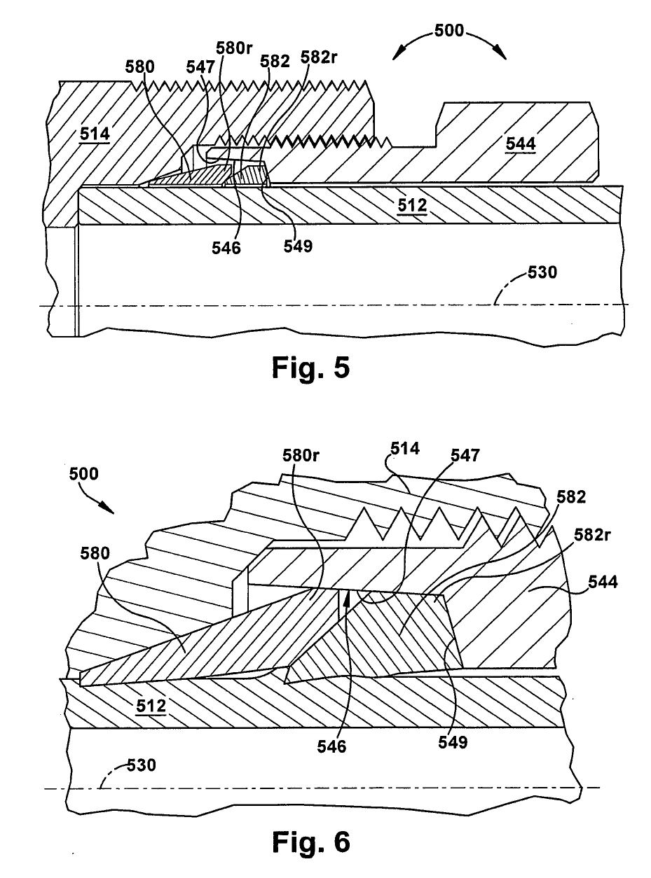

FIGS. 5 and 6 illustrate a fitting 500 that is yet another exemplary embodiment in which a tapered longitudinal surface 548 is provided on an inner wall of a drive nut 544. The exemplary fitting of FIGS. 5 and 6 is a two-ferrule fitting of the type utilizing a male threaded drive nut 544 and a female threaded fitting body 514, similar to a tube fitting with male threaded drive nut described in co-pending application Ser. No. 11/112,800, published under Pub. No. US 2005/0242582 and entitled Fitting for Tube and Pipe, the entire disclosure of which is fully incorporated herein by reference.

During pull-up of the illustrated tube fitting, axially and radially inward movement of a nose of the front ferrule 580 may cause an outer portion 580r of the front ferrule 580 to expand or deflect outward. Likewise, axially and radially inward movement of the inner, gripping portion of the rear ferrule 582 may case an outer portion 582r of the rear ferrule to expand or deflect outward. Under some circumstances, one or both of these outer portions 580r, 582r of the ferrules 580, 582 may contact an inner wall 546 of the drive nut 544 during initial or subsequent fitting pull-up, causing a radial reaction load between the outer portion 580r, 582r of the ferrule or ferrules 580, 582 and the inner wall 546 of the drive nut 544. In the exemplary embodiment of FIGS. 5 and 6, a tapered longitudinal surface 547 is provided on the inner wall 546 at a location axially aligned with and radially spaced from the ferrules 580, 582. When the outer portions 580r, 582r of the ferrules 580, 582 deflect during pull-up, as shown in FIG. 6, one or both of the outer portions 580r, 582r may contact the tapered longitudinal surface 547, resulting in both a radial and an axial component of reaction force between the contacting surfaces. The tapered condition of the inner wall surface 547 (as opposed to, for example, a cylindrical surface) can assist in separation of the nut 544 from the ferrules 580, 582 upon disassembly, as the axial component of reaction force can assist in separation of the nut 544 from the ferrule or ferrules 580, 582. Once the ferrule or ferrules 580, 582 are initially broken free from the tapered wall surfaces 547, the nut 544 can be separated without any substantial force, because of the taper angle of the tapered longitudinal surface.

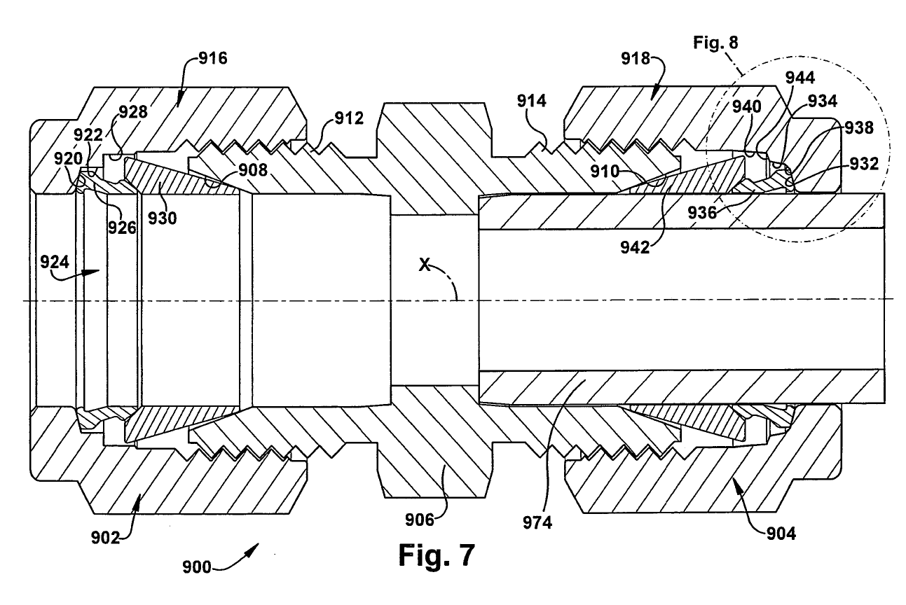

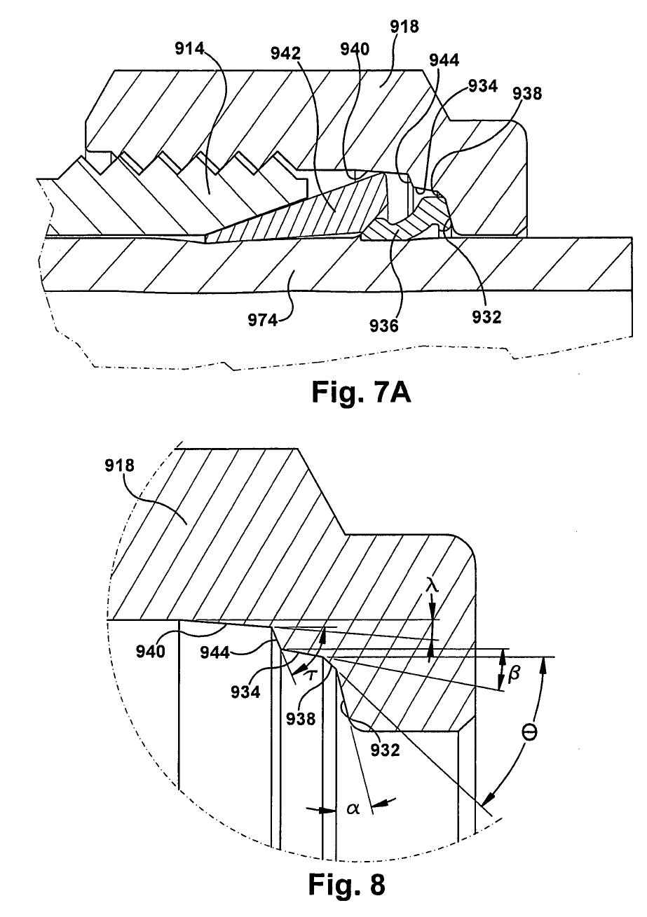

With reference to FIGS. 7 and 8 we illustrate another embodiment of a drive nut that incorporates tapered interior surfaces that may come into contact with one or more conduit gripping members such as ferrules upon completed pull-up of the fitting. FIG. 7 illustrates a union fitting 900 with a traditional tube fitting 902 illustrated on the left half of the union (as viewed in the drawing) and a fitting 904 in accordance with this embodiment of the invention on the right half of the drawing. The illustration of a union is but one example of many different applications of the inventions herein and is provided only to serve as an exemplary use but is not a limitation on the use of the inventions described herein. The union 900 includes a body 906 having a central longitudinal axis X, and at each end a tapered frusto-conical surface 908 and 910 and male threaded outer surfaces 912 and 914. The male threaded ends 912, 914 mate with respective female threaded drive nuts 916 and 918. In the traditional fitting 902, the drive nut 916 includes a drive surface 920 that in cross-section as shown is conical and has a typical angle relative to an axis that is normal to the axis X of about 15° although other angles for the drive surface 920 may be and commonly are used, even as shallow as 5°. The traditional nut body 916 further includes a longitudinal surface 922 that extends axially from the drive surface 920 and that with the drive surface defines a socket 924 that receives a backend of a tube gripping device 926 such as, for example, a back ferrule 926 of a two ferrule assembly. The nut body 916 may further include a second longitudinal surface 928 that extends axially from the first longitudinal surface 922 to form another socket that may receive the back end of a front ferrule or front tube gripping device 930.

Turning now to the right half of the drawing of FIG. 7 as well as FIG. 8, in an embodiment of the invention, the socket that is formed to receive the back end of the rear ferrule or gripping device includes tapered surfaces. This embodiment is similar in many respects to the embodiments of FIGS. 1-6 hereinabove, but an additional tapered surface has been added between the nut drive surface and the first tapered surface (see, for example, surface 348 in FIG. 1A). This additional tapered surface is particularly effective for fitting designs such as the one illustrated in FIG. 7 wherein the back end of the rear ferrule is designed to locate or be displaced away from and out of contact with the conduit upon complete pull-up, as part of a non-bowing hinging feature in which a central portion of the rear ferrule is radially deflected inward to swage against the wall of the conduit end 974 (see FIG. 7A).

The female nut body 918 thus includes a drive surface 932 that may be formed at a similar angle α as a traditional drive nut drive surface 920, or a different angle if needed for a particular fitting design. A first tapered surface 934 is provided that is radially outward of the drive surface 932, and extends axially away from the drive surface in a longitudinal direction and corresponds generally with the tapered surface 348 of FIG. 1A. This surface 934 is preferably axially aligned with a rearward portion of the rear ferrule 936 so that when the ferrule back end locates outwardly during pull-up, the ferrule back end can contact the tapered surface 934. The first tapered surface may be formed at an angle β with respect to the axis X, in a manner similar to the angle 343 in FIG. 1A, although different angle values may be used as required. For example, the angle β may be about 10°.

In contrast to the embodiment of FIGS. 1 and 1A, however, a second tapered surface 938 is provided between the drive surface 932 and the first tapered surface 934. This second tapered surface 938 provides a more gradual transition between the drive surface 932 and the first tapered surface 934 and may in some cases contact the back end of the rear ferrule when the fitting is assembled in a finger tight condition prior to final pull-up and tightening. Thus, the second tapered surface 938 may help center the back ferrule (or the back end of a single ferrule in single ferrule fittings) in the nut body, especially the socket formed by the drive surface 932 and the first and second tapered surfaces 934 and 938. The second tapered surface 938 in this embodiment is radially outward of the drive surface 932, and also in this example is contiguous with the radial outer end of the drive surface 932 and the radial inner end of the first tapered surface 934. The second tapered surface 938 may be formed at an angle θ relative to the axis X, such as for example about 45°, but the selected angle for any particular application may be different and will be determined in part by the values of α and β. As an alternative embodiment, the surface 938 may be realized as a radius or curved surface or may have a compound geometry comprising any number of profiles and sections including straight, elliptical, radius and other portions. The socket defined by the surface 932, 934 and 938 may likewise have different geometric profiles and elements as needed, rather than the illustrated conical profiles of those surfaces. In addition to centering the back ferrule 936 in the nut 918, the second tapered surface 938 may further contribute to the benefits achieved by the first tapered surface 934 as described above with respect to the FIGS. 1 and 1A embodiment.

The nut body 918 may thus further include a third tapered surface 940 that is axially aligned with a rearward portion of the front ferrule 942 and is radially outward of the drive surface 932 and the first and second tapered surfaces 934 and 938. This third tapered surface 940 may be formed at an angle λ, such as for example about 4°, similar to the angle 341 in the embodiment of FIG. 1A described hereinabove.

FIG. 7A illustrates a portion of the fitting 900 of FIG. 7 in a pulled-up condition in which the rear portion of the back ferrule 936 has been displaced radially outward and into increased engagement with the second or transitional tapered surface 938. Additionally, a radially outer portion of the front ferrule 942 has been displaced outward into contact with the third tapered surface 940. As shown, a gap may still remain between the radially outer portion of the back ferrule 936 and the first tapered surface 934. Contact between the back ferrule 936 and the first tapered surface 934 may occur during a subsequent pull-up of the fitting 900, after additional incremental outward displacement of the rear portion of the back ferrule 936 upon one or more additional fitting re-makes.

It will be noted that in the embodiment of FIG. 1A, there is a radial step region between the tapered surface 348 and the tapered surface 347. As an alternative, in the embodiment of FIGS. 7 and 8, a tapered transition 944 may be provided, formed at an angle τ relative to the axis X, such as for example, about 70°. This transition may ease manufacturing during the machining process. As with all the angle values described herein, other values may be used as needed. Typical ranges may include but need not be limited to the following examples: a from about 2° to about 25°; β from about 2° to about 25°; θ from about 30° to about 60°; λ from about 2° to about 25°; and τ from about 30° to about 88°.

The use of a second tapered surface between the nut drive surface and a first tapered surface in the nut socket that receives the back ferrule may also be applied to additional fitting embodiments and nut designs. For example, this additional tapered surface may be used with a male threaded nut such as illustrated in FIG. 5 hereof (adding a second tapered surface between the surface 549 and the surface 547 for example) or for the embodiments of FIGS. 3 and 4 hereof (adding a second tapered surface between the surfaces 447 and 449 for example.) The variations apply to single ferrule fittings and fittings with more than two ferrules and with fittings having significantly different ferrule or gripping device shapes and geometries.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

1. A drive nut for a fitting, comprising:
an interior socket centered on a central axis and configured to receive at least a rearward portion of a conduit gripping member, the socket being defined by a radial drive surface positioned to engage the conduit gripping member during pull-up; a first tapered longitudinal surface radially outward of said drive surface and a second tapered longitudinal surface extending from the drive surface to the first tapered longitudinal surface, the second tapered longitudinal surface being angled with respect to both the drive surface and the first tapered longitudinal surface.

2. The drive nut of claim 1, wherein the second tapered longitudinal surface extends at an angle between approximately 30° and approximately 60° with respect to the central axis.

3. The drive nut of claim 1, wherein the second tapered longitudinal surface extends at an angle of approximately 45° with respect to the central axis.

4. The drive nut of claim 1, wherein the first tapered longitudinal surface extends at an angle between approximately 2° and approximately 25° with respect to the central axis.

5. The drive nut of claim 1, wherein the first tapered longitudinal surface extends at an angle of approximately 10° with respect to the central axis.

6. The drive nut of claim 1, further comprising a third tapered longitudinal surface radially outward of the first tapered longitudinal surface, the third tapered longitudinal surface being angled with respect to the first tapered longitudinal surface.

7. The drive nut of claim 6, wherein the third tapered longitudinal surface extends at an angle between approximately 2° and approximately 25° with respect to the central axis.

8. The drive nut of claim 6, wherein the third tapered longitudinal surface extends at an angle of approximately 4° with respect to the central axis.

9. The drive nut of claim 6, further comprising a stepped wall surface extending radially between the first and third tapered longitudinal surfaces, the stepped wall surface being angled with respect to the first and third tapered longitudinal surfaces.

10. The drive nut of claim 9, wherein the stepped wall surface is tapered.

11. The drive nut of claim 9, wherein the stepped wall surface extends at an angle between approximately 30° and approximately 88° with respect to the central axis.

12. The drive nut of claim 9, wherein the stepped wall surface extends at an angle of approximately 70° with respect to the central axis.

13. The drive nut of claim 1, further comprising a female threaded portion for assembly with a male threaded fitting body.

14. A tube fitting, comprising:
a tube gripping device including a first ferrule;
a fitting body having a tube end socket for receiving a tube end; and
a drive nut for assembly with the fitting body, the drive nut comprising a recessed portion sized to receive the first ferrule, the recessed portion including a radial drive surface for driving the first ferrule into engagement with a tube end during pull-up on the fitting body; a first tapered longitudinal surface that is radially spaced from a radially outer surface of the first ferrule when the tube fitting is in a finger-tight condition, and a second tapered longitudinal surface between the drive surface and the first tapered longitudinal surface, the second tapered longitudinal surface being angled with respect to both the drive surface and the first tapered longitudinal surface,
wherein when the drive nut is pulled up with the fitting body, the first ferrule is radially displaced into contact with the first tapered longitudinal surface.

15. The tube fitting of claim 14, wherein the second tapered longitudinal surface extends from the drive surface to the first tapered longitudinal surface.

16. The tube fitting of claim 14, wherein the tube gripping device further includes a second ferrule, the second ferrule being at least partially received in a camming mouth of the fitting body.

17. The tube fitting of claim 16, wherein the drive nut further comprises a third tapered longitudinal surface that is radially spaced from a radially outer surface of the first ferrule when the tube fitting is in a finger-tight condition prior to pull-up, wherein when the drive nut is pulled up with the fitting body, the second ferrule is radially displaced into contact with the third tapered longitudinal surface.

18. The tube fitting of claim 17, wherein the second and third tapered longitudinal surfaces are discontinuous.

19. The tube fitting of claim 17, wherein the drive nut further comprises a stepped wall surface extending radially between the first and third tapered longitudinal surfaces, the stepped wall surface being angled with respect to the first and third tapered longitudinal surfaces.

20. The tube fitting of claim 19, wherein the stepped wall surface is tapered.

21. The tube fitting of claim 13, wherein the first ferrule engages the second tapered longitudinal surface when the tube fitting is in a finger tight condition prior to pull-up.

22. A method of assembling a tube fitting with a tube end, the tube fitting comprising a fitting body, a drive nut, and a ferrule, the method comprising:
inserting the tube end into a tube end socket of the fitting body;
positioning the ferrule in a recessed portion of the drive nut;
assembling the drive nut with the fitting body to a finger-tight position, such that the ferrule engages a radial drive surface of the drive nut and is radially spaced from a first tapered longitudinal surface of the drive nut by at least a portion of a second tapered longitudinal surface disposed between the drive surface and the first tapered longitudinal surface; and
pulling up the drive nut on the fitting body, such that the ferrule is radially displaced into contact with the first tapered longitudinal surface.

23. The method of claim 22, wherein assembling the drive nut with the fitting body to a finger-tight condition comprises engaging the ferrule with the second tapered longitudinal surface to center the ferrule within the recessed portion of the drive nut.
